(19) United States
(12) Patent Application Publication
(10) Pub. No.: US 2016/0132016 A1
(43) Pub. Date: May 12, 2016

(54) IMAGE FORMING APPARATUS AND LUBRICATING METHOD FOR THE SAME

(71) Applicants: KABUSHIKI KAISHA TOSHIBA, Tokyo (JP); TOSHIBA TEC KABUSHIKI KAISHA, Tokyo (JP)

(72) Inventors: Susumu Takahashi, Numazu (JP); Satoshi Hatakeyama, Yokohama (JP); Yoshihiko Sugiyama, Hasuda (JP)

(21) Appl. No.: 14/536,879

(22) Filed: Nov. 10, 2014

(51) Int. Cl. G03G 21/00

(52) U.S. Cl. CPC G03G 21/0094

(57) ABSTRACT

Certain embodiments provide an image forming apparatus including a drum configured to include a drum surface which rotates around a shaft in a rotation direction; a blade configured to clean residual toner after a toner image on the drum surface is transferred to a transfer-receiving member; and a holding section configured to hold a lubricant arranged in the blade at the upstream side of the blade in the rotation direction and cover both ends in a longitudinal direction of the blade on the drum surface.

### FIELD

Embodiments described herein relate generally to an image forming apparatus and a lubricating method for the same.

### BACKGROUND

An image forming apparatus scrapes the toner left on the surface (hereinafter, referred to as drum surface) of a photoconductive drum (hereinafter, referred to as drum) after transferring a toner image to a sheet.

In the relating technology, the performance of a cleaning device is maintained by maintaining the size of the gap between the front end of a cleaning blade and the drum. The performance refers to the toner cleaning performance. A lubricant is coated on the drum surface and the cleaning blade to maintain the cleaning performance and the abrasion resistance, and to prevent the occurrence of blade curling.

In the relating technology, there is known a cleaning device which forms, at the edge of the cleaning blade and the drum surface, an area in which the residual toner passing through the blade and the lubricant are stored.

However, in the manufacturing stage of the image forming apparatus, the lubrication is not sufficient between the drum surface and the cleaning blade, thus, blade curling occurs due to the friction force. The blade curling refers to that the center part in the longitudinal direction of the main blade is deformed in the drum rotation direction. The blade curling cannot be prevented in the initial use stage of the image forming apparatus.

### BRIEF DESCRIPTION OF THE DRAWINGS

FIG. 1 is a diagram illustrating the constitution of an image forming apparatus according to one embodiment;

FIG. 2 is a diagram illustrating the arrangement relation between a blade and a drum of the image forming apparatus according to the embodiment;

FIG. 3 is a front view illustrating a cleaning device used in the image forming apparatus according to the embodiment;

FIG. 4 is an enlarged perspective view illustrating one part of the cleaning device used in the image forming apparatus according to the embodiment;

FIG. 5A is a front view illustrating the drum of the image forming apparatus according to the embodiment;

FIG. 5B is a cross-sectional view of the drum of the image forming apparatus according to the embodiment; and

FIG. 6 is an enlarged view illustrating the front end of a main blade of the image forming apparatus according to the embodiment.

### DETAILED DESCRIPTION

Certain embodiments provide an image forming apparatus including a drum configured to include a drum surface which rotates around a shaft in a rotation direction; a blade configured to clean residual toner after a toner image on the drum surface is transferred to a transfer-receiving member; and a holding section configured to hold a lubricant arranged in the blade at the upstream side of the blade in the rotation direction and cover both ends in a longitudinal direction of the blade on the drum surface.

Certain embodiments provide a lubricating method of an image forming apparatus including: transferring a toner image on a drum surface to a transfer-receiving member at a first rotation position in a rotation direction of a drum which rotates around a shaft; cleaning residual toner after the transfer processing with a blade at a second rotation position at the downstream side of the first rotation position in the rotation direction; and lubricating the drum surface through the rotation of the drum and a lubricant arranged in the blade at the upstream side of the blade in the rotation direction.

Hereinafter, an image forming apparatus and a lubricating method of an image forming apparatus are described in detail with reference to the accompanying drawings. Further, the same components are indicated by the same reference numerals in the drawings and repetitive description is not provided.

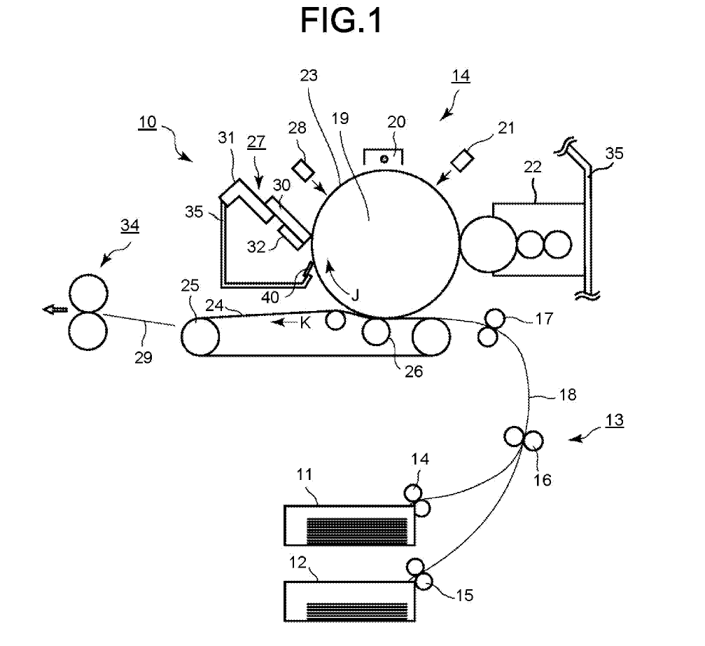

FIG. 1 is a diagram illustrating the constitution of the image forming apparatus according to the embodiment.

An image forming apparatus 10 includes cassettes 11 and 12, a sheet conveyance section 13, an image forming section 14 and a fixing device 34.

The cassettes 11 and 12 supply a sheet to the image forming section 14. The conveyance section 13 includes pickup roller pairs 14 and 15, a conveyance roller pair 16, a register roller pair 17 and a guide 18.

The image forming section 14 includes a drum 19, a charger 20, an exposure device 21 and a developing device 22. The drum 19 serving as a photoconductive drum rotates in a direction indicated by an arrow J. The direction J is such a direction in which the drum 19 rotates along with the rotation of a belt 24.

The drum 19 includes a cylinder which rotates around a shaft and a drum surface 23 including a photoconductor layer.

The charger 20 is an electrostatic charger. The exposure device 21 irradiates the drum surface 23 with laser light. The developing device 22 visualizes an electrostatic latent image with toner. The toner also includes a lubricant. For example, zinc stearate is blended with the toner.

Further, the image forming section 14 includes the belt 24, a drive roller 25, a transfer roller 26, a cleaning device 27 and a charge removing lamp 28. The belt 24 is a transfer belt which endlessly rotates in a direction indicated by an arrow K below the drum 19. The direction K is the rotation direction of the belt 24. The rotation direction of the belt 24 is the conveyance direction of the sheet.

The transfer roller 26 is located at the side of the inner peripheral surface of the belt 24. The transfer roller 26 can be moved upwards or downwards. The transfer roller 26 applies a transfer bias to the sheet conveyed by the belt 24. The polarity of the transfer bias is opposite to that of the toner.

The cleaning device 27 cleans the toner left on the drum surface 23. The cleaning device 27 includes a main blade 30, a metal plate 31, two stickers 32 and 33 (only the sticker 32 at one side is shown), and a case 35.

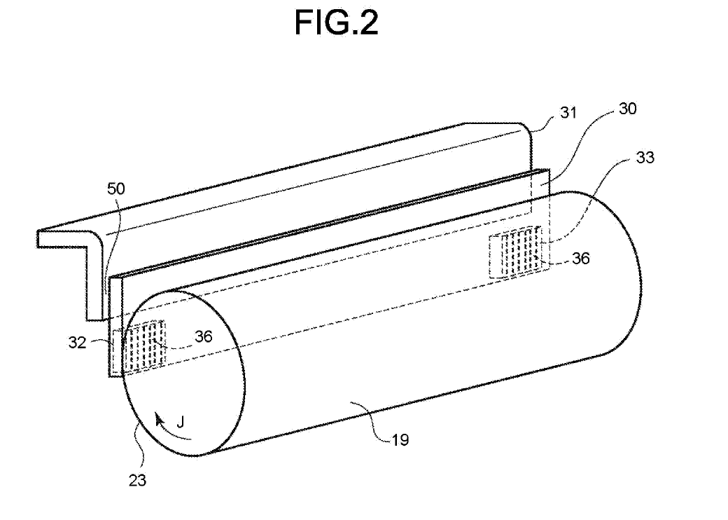

FIG. 2 is a diagram illustrating the arrangement relation between the main blade 30 and the drum 19. The same reference numerals indicate the same components as those shown in FIG. 1.

The image forming apparatus 10 is provided with the drum 19 which includes the drum surface 23 rotating around a shaft in the rotation direction J, the main blade 30 (blade) which cleans the toner left on the drum surface 23 after the toner image on the drum surface 23 is transferred to the belt 24 (transfer-receiving member), and the metal plate 31 for fixing the main blade 30.

The image forming apparatus 10 is provided with the stickers 32 and 33 (lubricant holding sections) arranged on the main blade 30 at the upstream side of the main blade 30 in the rotation direction. The stickers 32 and 33 cover the two ends in the longitudinal direction of the blade on the drum surface 23.

The sticker 32 includes a sticker surface at the upstream side in rotation direction J and a sticker surface at the downstream side in rotation direction J, and grooves 36 are arranged on the upstream surface. The sticker 33 is structurally identical to the sticker 32.

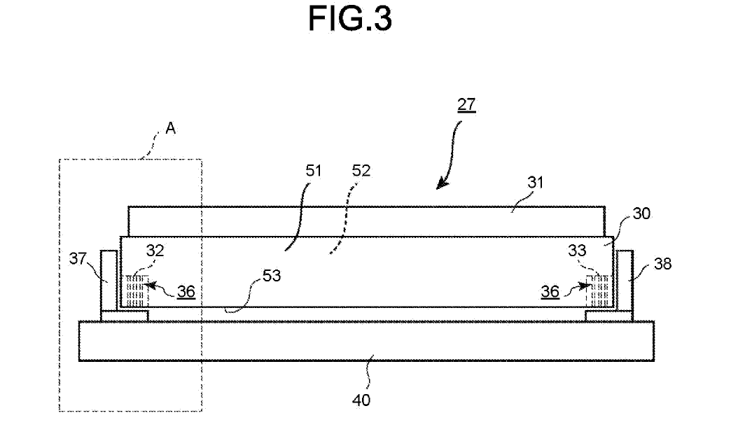

FIG. 3 is a front view illustrating the inner structure of the cleaning device 27. The same reference numerals indicate the same components as those shown in FIG. 1 and FIG. 2.

The main blade 30 is a flexible cleaning blade formed by urethane resin. The longitudinal direction of the main blade 30 is parallel to the rotation shaft of the drum 19. The blade length (the length of the main blade 30 in the longitudinal direction) is longer than the toner image range of the drum 19.

The main blade 30 has a front surface 51, a back surface 52 and an edge 53. The back surface 52 is adhered to the surface of the metal plate 31 through an adhesive 50 (FIG. 2). The edge 53 scrapes the toner left on the drum surface 23.

The stickers 32 and 33 serving as members face an area overlapping with the image forming area on the drum surface 23.

Both the stickers 32 and 33 are stuck to the back surface 52 of the main blade 30 close to the edge 53.

The material of both the stickers 32 and 33 is polyether-based urethane. Both the stickers 32 and 33 have a certain thickness. Each of the stickers 32 and 33 includes a plurality of grooves 36 for holding the lubricant. Each groove 36 holds the lubricant.

The groove 36 is formed in advance. The number of grooves on each of the stickers 32 and 33 may be 3-5. The grooves 36 on the sticker 32 are parallel to the grooves 36 on the sticker 33.

The lubricant essentially contains the toner, polyvinylidene fluoride resin powder, zinc stearate powder, or one or two or more categories of mixtures of these materials.

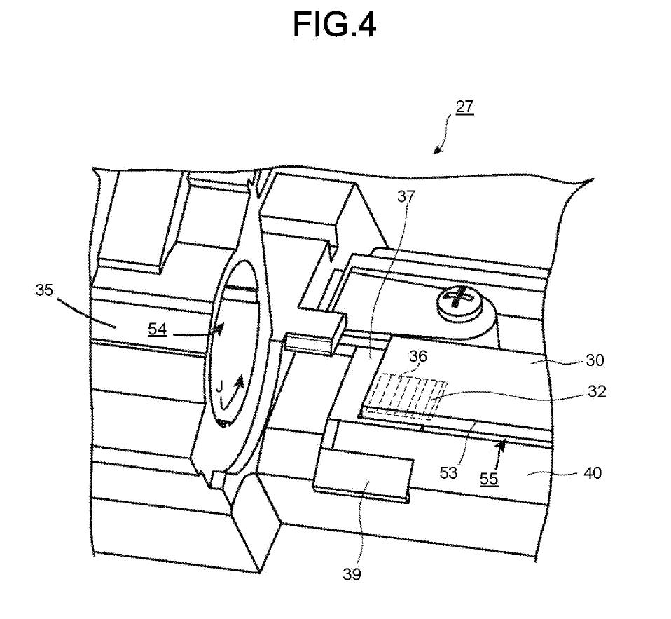

FIG. 4 is an enlarged perspective view illustrating the part indicated by the frame A in FIG. 3. The same reference numerals indicate the same components as those shown in FIG. 1-FIG. 3.

A space 54 is part of the bearing of the drum 19.

The cleaning device 27 may include a recovery blade 40 (another blade) . The recovery blade 40 of the cleaning device 27 is arranged at the upstream side of the main blade 30 in the rotation direction J.

The recovery blade 40 may catch the toner scraped by the main blade 30. The catch of the toner refers to guiding the toner from the edge 53 to a space 55. The cleaning device 27 fixes the recovery blade 40 on the case 35 through a fastener 39.

The cleaning device 27 may include L-shaped side seals 37 at the left and the right sides. The pair of side seals 37 seals the opening space to prevent the residual toner from scattering. The side seals 37 seal the opening space to prevent the scraped toner from scattering in the machine. The components around the sticker 33 are the same as those around the sticker 32.

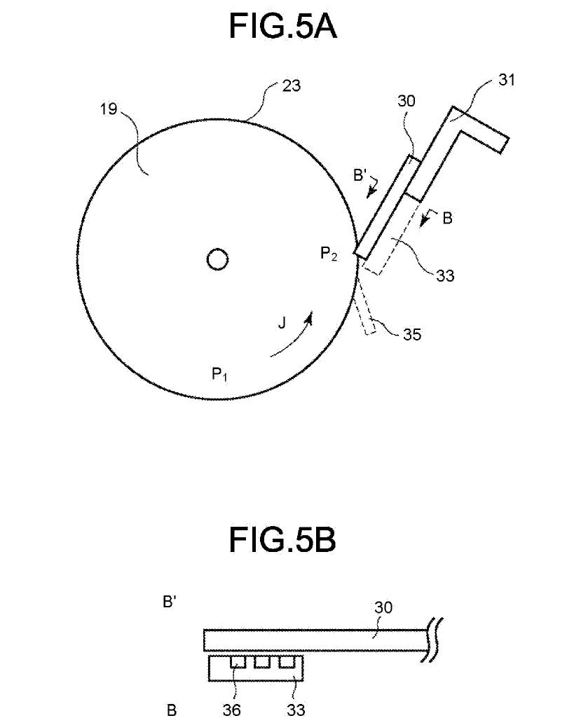

FIG. 5A is a front view illustrating the drum 19 of the image forming apparatus 10. The direction of the front surface of the drum shown in FIG. 5A is different from that shown in FIG. 1. The same reference numerals indicate the same components as those shown in FIG. 1-FIG. 4.

The lubricating method of the image forming apparatus according to the embodiment includes:

transferring the toner image on the drum surface 23 to the sheet at a rotation position P₁ in the rotation direction J of the drum 19;

cleaning the residual toner after the transfer processing with the main blade 30 at a rotation position P₂ at the downstream side of the rotation position P₁ in the rotation direction J; and

lubricating the drum surface 23 through the rotation of the drum 19 and the lubricant from the sticker 33 arranged at the upstream side of the main blade 30 in the rotation direction J.

FIG. 5B is a cross sectional view of the drum 19 taken in the direction of the arrows BB′. The sticker 33 supplies the lubricant in the grooves 36 to the drum surface 23. The same reference numerals indicate the same components as those shown in FIG. 1-FIG. 5A. The sticker 32 is structurally identical to the sticker 33.

Next, the operations of the image forming apparatus 10 having the constitution described above are described.

The lubricant is held in the stickers 32 and 33 in advance when the image forming apparatus 10 is manufactured initially. For example, it is preferred that the weight of the lubricating material is more than 0.01 gram. The weight is determined through experiments and tests.

Lubrication powder may be coated on the drum surface 23 and the belt 24 directly.

The powder is fine particles containing the polyvinylidene fluoride (bunch powder (registered trademark)). The zinc stearate powder serving as the lubricant is mixed with the toner supplied to the developing device 22.

In the manufacturing stage before the image forming apparatus 10 is started to be used, the cleaning device 27 including the stickers 32 and 33 is arranged in the image forming apparatus 10.

In the manufacturing line, or in the initial use stage, the lubricant L is supplied from the grooves 36 of the stickers 32 and 33 to the drum surface 23. In the manufacturing line, an operator or a manufacturing device rotates the drum 19 in the rotation direction J for one circle. In this way, the entire circumferential surface of the drum surface 23 is covered with the lubricant L.

The lubricant L reduces the friction between the drum surface 23 and the edge 53. Similar to the sticker 33, the sticker 32 also lubricates the drum surface 23. The friction between the drum 19 and the main blade 30 is reduced through the lubricant L from the stickers 32 and 33.

When the image forming apparatus 10 is operated initially, the main blade 30 is slightly vibrated during the cleaning processing. Through the vibration, the lubricant in the plurality of grooves 36 is slowly supplied to the drum surface 23 along the grooves 36.

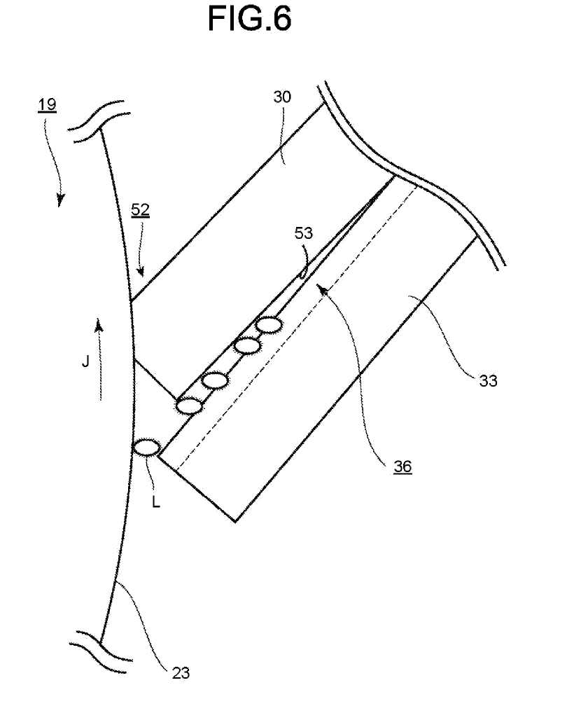

FIG. 6 is an enlarged view illustrating the front end of the blade of the main blade 30. FIG. 6 also illustrates the position relation between the sticker 33 and the drum surface 23. The existing reference numerals described above indicate the same components.

The main blade 30 receives an upward load from the drum 19 and is deflected slightly, and in this way, gap is generated between the grooves 36 of the sticker 33 and the back surface 53 of the main blade 30.

The dropping of the lubricant L can be accelerated due to the gap. The lubricant L held in the grooves 36 of the stickers 32 and 33 is dropped from the back surface 53. The lubricant L adheres to the drum surface 23 and the main blade 30.

After the image forming apparatus 10 is manufactured, the friction force between the main blade 30 and the drum 19 can be reduced, which can prevent the blade from being curled. In this way, the curl-resistance of the blade is improved, and the quality in the initial stage can be improved.

As to the description of the operations of the image forming apparatus 10, after the manufacturing process, the stickers 32 and 33 are arranged in the cleaning device 27 in a state in which the lubricant is held in the grooves 36. The image forming apparatus 10 is arranged in an office.

The conveyance section 13 of the image forming apparatus 10 picks up the sheet set in the, cassette 11. Alternatively, the conveyance section 13 picks up, from the cassette 12, the sheet having a size different from that of the sheet in the cassette 11.

The charger 20 of the image forming section 14 charges the drum surface 23. The exposure device 21 forms an electrostatic latent image on the drum surface 23. The developing device 22 develops the electrostatic latent image with the toner. The image forming section 14 rotates the drum 19 in the rotation direction J through the driving of a motor.

The drive roller 25 rotates the belt 24 at the same circumferential speed as that of the drum 19. A plurality of other rollers are arranged to apply tension to the belt 24.

The transfer roller 26 contacts with the drum surface 23 across the belt 24. The transfer roller 26 transfers the toner image to the sheet through the generation of electric field. The transfer roller 26 is separated from the drum surface 23. The fixing device 34 fixes the toner image. In this way, the image forming apparatus 10 forms the image on the sheet.

Further, the cleaning device 27 (FIG. 5) contacts with the drum surface 23 through the edge 53 of the main blade 30. As shown in FIG. 6, the lubricant L from the grooves 36 is dropped to the drum surface 23. The drum surface 23 is lubricated while the drum 19 rotates.

The upper long side (FIG. 3) of the main blade 30 is fixed on the metal plate 31. The edge 53 of the main blade 30 applies force to the drum surface 23 through the elastic repulsive force of the main blade 30.

The edge 53 intercepts the toner left on the drum surface 23. The intercepted toner mass grows and then falls into the space 55. In this way, the residual toner is scraped. The charge removing lamp 28 removes the charge left on the drum surface 23. The fixing device 34 fixes the toner on the sheet from the guide 29. The equal force in the longitudinal direction is applied to the main blade 30. The service life of the main blade 30 can be extended to the technical life.

The image forming apparatus according to the relating technology is not provided with the stickers 32 and 33. In the cleaning device without the stickers 32 and 33, the blade is curled in the initial use stage of the image forming apparatus according to the relating technology. The curling of the blade generally occurs at the two ends in the longitudinal direction of the blade.

That is because the L-shaped side seals arranged at the two ends of the blade in the image forming apparatus according to the relating technology have a function of scraping residual toner and a function of preventing the scraped toner from scattering in the machine.

The image forming apparatus 10 has a function of holding the lubricant L for preventing the blade curling in the stickers 32 and 33 arranged at the two ends of the blade, in this way, the resistance caused by the friction between the drum 19 and the main blade 30 can be reduced.

In the initial machine setup processing of the image forming apparatus 10, the defect caused by the initial blade curling can be prevented.

Sequentially, the image forming apparatus 10 carries out copying (printing) processing generally. In the image forming processing, the drum surface 23 is lubricated by the lubricant (for example, stearic acid) contained in the toner, and the blade curling-resistance can be improved, thereby maintaining the function of the image forming apparatus 10.

The blade curling in the image forming apparatus according to the relating technology degrades the quality of the drum and the main blade. The blade curling further significantly impairs the quality of the main body of the manufactured machine (image forming apparatus). If the cleaning device includes no the stickers 32 and 33, the service life of the image forming apparatus does not even last for a year in the worst case. The toner stacks on the surface facing the image forming area.

On the contrary, the image forming apparatus 10 according to the embodiment can prevent the blade curling in the manufacturing stage before the image forming apparatus 10 is started to be used through the cleaning device provided with the stickers 32 and 33.

In a case in which the manufactured machine is operated for the first time, or in a case of a new manufactured machine, the lubricant is supplied to reduce the friction between the drum surface 23 and the main blade 30. Blade curling does not occur in the initial use due to the lubricant of the grooves 36 of the stickers 32 and 33.

As stated above, in accordance with the image forming apparatus and the lubricating method of the present embodiment, a plurality of grooves 36 are formed in the stickers 32 and 33 in advance, and the lubricant is held in the grooves 36, which can prevent the initial blade curling.

During the cleaning process, the main blade 30 is slightly vibrated, in this way, the lubricant is slowly supplied to the drum 19 along the grooves 36. The service life of the cleaning device 27 can be extended.

In accordance with the image forming apparatus and the lubricating method of the present embodiment, the residual toner is scraped at the downstream side in the rotation direction J of the drum 19 to prevent the toner from scattering. No scratch or almost no scratch is caused on the drum surface 23 due to the blade curling. The occurrence of image noise is prevented. The quality of the main body of the manufactured machine can be maintained.

In addition, even if the lubricant L from the grooves 36 is used up, the drum surface 23 and the main blade 30 can be lubricated through other lubricant contained in the toner and the like.

In the embodiment described above, the lubricant holding section is the stickers 32 and 33. The holding section may be a label, film, tape or decal instead of the stickers 32 and 33. Alternatively, the holding section may be a thin plate. The grooves 36 may be arranged on the label or the thin plate and the like.

Furthermore, transfer efficiency is influenced by the printing environment (for example, temperature; humidity; various biases of the transfer, development, charging and the like; transfer time), the sheet size and the paper category.

No specific limitation is given to the cross-sectional shape of the grooves 36. The advantages of the image forming apparatus and the lubricating method of the image forming apparatus will not be compromised in any way even if the cross-sectional shape of the grooves is changed.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

1. An image forming apparatus comprising:
a drum configured to include a drum surface which rotates around a shaft in a rotation direction;
a blade configured to clean residual toner after a toner image on the drum surface is transferred to a transfer-receiving member;
a holding section configured to hold a lubricant arranged on the blade at the upstream side of the blade in the rotation direction and cover both ends in a longitudinal direction of the blade; and
a plurality of sticker members configured to supply the lubricant to the drum, wherein when the drum rotates, the supply of lubricant to the drum starts.

2. The image forming apparatus according to claim 1, wherein
the holding section includes the plurality of sticker members each of which faces an area overlapping with an image forming area on the drum surface.

3. The image forming apparatus according to claim 1, wherein
the holding section includes a plurality of grooves each of which holds the lubricant.

4. The image forming apparatus according to claim 2, wherein
the sticker member includes a plurality of grooves each of which holds the lubricant.

5. The image forming apparatus according to claim 1, wherein
the holding section includes plurality of grooves are arranged on a surface of the holding section; and
the surface of the holding section faces the upstream side of the blade.

6. The image forming apparatus according to claim 2, wherein
the sticker member includes plurality of grooves are arranged on a surface of the sticker member; and
the surface of the sticker member faces the upstream side of the blade.

7. The image forming apparatus according to claim 1, wherein
the holding section is arranged at the back surface of the blade close to the edge of the blade.

8. The image forming apparatus according to claim 2, wherein
the sticker member is arranged at the back surface of the blade close to the edge of the blade.

9. The image forming apparatus according to claim 2, wherein
the sticker member includes a material containing polyether-based urethane foam.

10. The image forming apparatus according to claim 1, wherein
the lubricant contains at least one of: the toner, polyvinylidene fluoride resin powder, zinc stearate powder, and a mixture of these materials.

11. The image forming apparatus according to claim 1, further comprising:
a recovery blade positioned at the upstream side of the blade in the rotation direction to catch the residual toner.

12. A lubricating method of an image forming apparatus comprising:
transferring a toner image on a drum surface to a transfer-receiving member at a first rotation position in a rotation direction of a drum which rotates around a shaft;
cleaning residual toner after transfer processing with a blade at a second rotation position at the downstream side of the first rotation position in the rotation direction; and
lubricating the drum surface through the rotation of the drum and a lubricant arranged on the blade at the upstream side of the blade in the rotation direction, wherein when the drum rotates, the lubrication of the drum starts.

13. The lubricating method according to claim 12, wherein
a plurality of sticker members are arranged, as holding sections, to face an area overlapping with an image forming area on the drum surface.

14. The lubricating method according to claim 12, wherein
the lubricant is held in each of a plurality of grooves formed in a holding section.

15. The lubricating method according to claim 13, wherein
the lubricant is held in each of a plurality of grooves formed in the sticker members.

16. The lubricating method according to claim 12, wherein
the lubricant flows out from a plurality of grooves formed on a first surface of a holding section, the first surface of the holding section facing the upstream side of the blade in the rotation direction.

17. The lubricating method according to claim 13, wherein
the lubricant flows out from a plurality of grooves formed on a first surface of the sticker member, the first surface of the sticker member facing the upstream side of the blade in the rotation direction.

18. The lubricating method according to claim 16, wherein
the blade is deflected towards the downstream side in the rotation direction, thus, the lubricant flows out.

19. The lubricating method according to claim 17, wherein
the blade is deflected towards the downstream side in the rotation direction, thus, the lubricant flows out.

20. The lubricating method according to claim 12, wherein
the lubricant contains at least one of: the toner, polyvinylidene fluoride resin powder, zinc stearate powder, and a mixture of these materials.
